(19) United States
(12) Patent Application Publication
(10) Pub. No.: US 2025/0305460 A1
(43) Pub. Date: Oct. 2, 2025

(54) AN ASSEMBLY TO TURN OFF CYLINDERS OF AN ENGINE TO REDUCE LOAD FROM A CRANKSHAFT

(71) Applicants: Satarupa KABASI, West Bengal (IN); Samar CHOUDHURY, West Bengal (IN)

(72) Inventor: Samar CHOUDHURY, West Bengal (IN)

(21) Appl. No.: 18/865,756

(22) PCT Filed: Apr. 19, 2023
(86) PCT No.: PCT/IB2023/054000

§ 371 Date: Nov. 14, 2024

(30) Foreign Application Priority Data
May 14, 2022 (IN) 202231027828

(51) Int. Cl. F02D 13/06; F02D 9/10; F02D 41/00

(52) U.S. Cl. CPC F02D 13/06; F02D 9/101; F02D 41/0002

(57) ABSTRACT

An assembly (100) to turn off one or more cylinders of an engine to reduce load from a crankshaft is disclosed. The assembly (100) includes one or more butterfly valves (104) of a pre-defined shape housed inside one or more corresponding cylinders of the engine. Each of the one or more butterfly valves (104) comprises at least one hole (106) at a pre-defined position in the corresponding at least one butterfly valve (104), and configured to reduce effect of negative pressure. The assembly also includes at least one actuator operatively coupled to the corresponding one or more butterfly valves (104). The at least one actuator is configured to operate the corresponding cylinders of the engine.

### FIELD OF DISCLOSURE

The present disclosure relates to cylinder deactivation technology. More particularly, the present disclosure relates to an assembly to turn off one or more cylinders of an engine to reduce load from a crankshaft.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Cylinder Deactivation, or CDA, is a technique in multi-cylinder engines where a combination of cylinders is systematically disabled, effectively reducing the engine's displacement, improving overall engine efficiency and fuel economy. It can be achieved by a conventional system, where, in a commercial vehicle engine passenger car engine which may be manufactured by various manufacturer last many years where intake valve closes to stop the air flow inside engine cylinder when engine is running in a no-load condition. To execute the intake valve operation for closing, the conventional system uses complicated camshaft modification or rocker arm modification or hydraulic lash modification. However, these technologies of the conventional system are very complicated design, require high degree of precision of component tolerance, some design requires good quality of engine oil, includes high production cost, and is also difficult to diagnose, due to which repair time is high.

In addition, manifold technology used by various manufacturers is not gaining much improvement in terms of mileage. Further, Variable compression engine designs are also being used mainly in laboratory: however, this is not being used in commercial application due to its complicated design and maintenance. Also, in In V6 or V8 engines, fuel injection stops only during cruise speed but does not eliminate compression load from the crankshaft. In comparison, a few manufacturers use cylinder deactivation technology by designing a very complicated intake valve operation which is costly and is also difficult to implement. Fault diagnosis and repair are also not easy tasks. The system in such technology is also heavily relied on quality engine oil.

Therefore, there is a need in the art to provide an improved assembly to turn off one or more cylinders of an engine to reduce load from a crankshaft that overcomes above-mentioned and other limitations of existing approaches.

### OBJECTS OF THE INVENTION

Some of the objects of the present disclosure, which at least one embodiment herein satisfies, are as listed herein below.

It is an object of the present disclosure to provide an improved cylinder deactivation system by closing the intake port with a butterfly valve attached with a actuator and operated by ECM.

It is another object of the present disclosure to provide a deactivation system which has less production cost and has easy implementation in an existing petrol or diesel engine.

It is yet another object of the present disclosure to provide a deactivation system with an engine to start faster with existing self-stater as the load will be less on crankshaft if close two cylinders and for future engines self-starter and battery cost can be minimized.

It is yet another object of the present disclosure to provide a deactivation system which can replace the multicylinder industrial engines having two self-starters to start easily using less torque.

It is yet another object of the present disclosure to provide a deactivation system which can reduce the negative pressure inside the cylinder (and no effect is produced during compression stroke as the air entered is just the double volume of clearance volume. Hence the deactivation system will be 10% more efficient during cylinder deactivation as compared to the existing systems.

### SUMMARY

This summary is provided to introduce simplified concepts of a system and method for dynamic evasive trajectory planning of a host vehicle on a road, which are further described below in the Detailed Description. This summary is not intended to identify key or essential features of the claimed subject matter, nor is it intended for use in determining/limiting the scope of the claimed subject matter.

An aspect of the present disclosure relates to an assembly to turn off one or more cylinders of an engine to reduce load from a crankshaft. The assembly includes one or more valves of a pre-defined shape housed inside one or more corresponding cylinders of the engine. Each of the one or more valves comprises at least one hole at a pre-defined position in the corresponding at least one valve, and configured to reduce effect of negative pressure. The assembly also includes at least one actuator operatively coupled to the corresponding one or more valves. The at least one actuator is configured to operate the corresponding cylinders of the engine.

Various objects, features, aspects and advantages of the present disclosure will become more apparent from the following detailed description of preferred embodiments, along with the accompanying drawing figures in which like numerals represent like features.

Within the scope of this application, it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and together with the description, serve to explain the principles of the present disclosure. The diagrams are for illustration only, which thus is not a limitation of the present disclosure, and wherein:

FIG. 1 illustrates a schematic representation of one or more valves of a pre-defined shape of an assembly to turn off one or more cylinders of an engine, in accordance with an aspect of the present invention.

FIG. 2 illustrates a schematic representation of a hole of predefined dimension of the assembly to turn off the one or more cylinders of the engine of FIG. 1, in accordance with an aspect of the present invention.

FIG. 3a illustrates a schematic representation of an embodiment representing two types of placement of the valves using the assembly to turn off a four cylinders engine of FIG. 1, in accordance with an aspect of the present invention.

FIG. 3b illustrates a schematic representation of another embodiment representing

two types of placement of the valves using the assembly to turn off the four cylinders engine of FIG. 1, in accordance with an aspect of the present invention.

FIG. 3c illustrates a schematic representation of another embodiment representing two types of placement of the valves using the assembly to turn off the six cylinders engine of FIG. 1, in accordance with an aspect of the present invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments: on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present disclosure relates to cylinder deactivation technology. More particularly, the present disclosure relates to an assembly to turn off one or more cylinders of an engine to reduce load from a crankshaft.

In one embodiment, the engine may be of any vehicle which may include one of a petrol engine or a diesel engine.

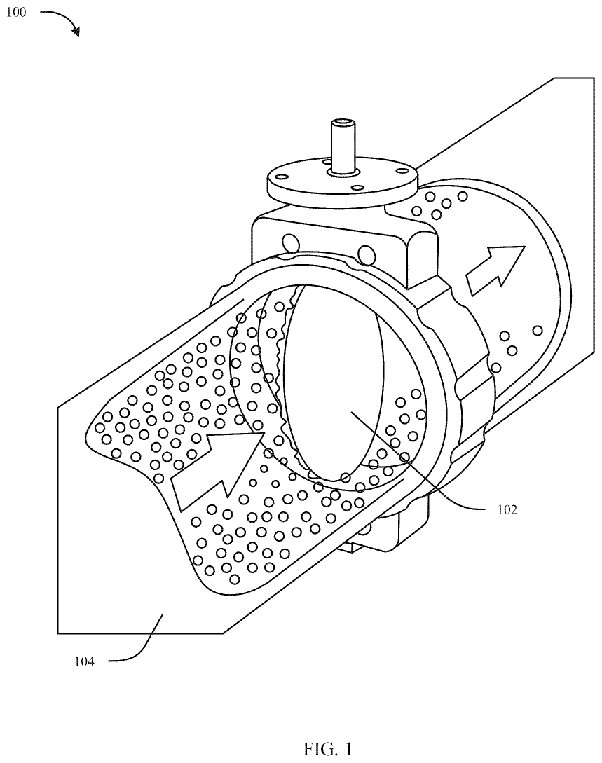

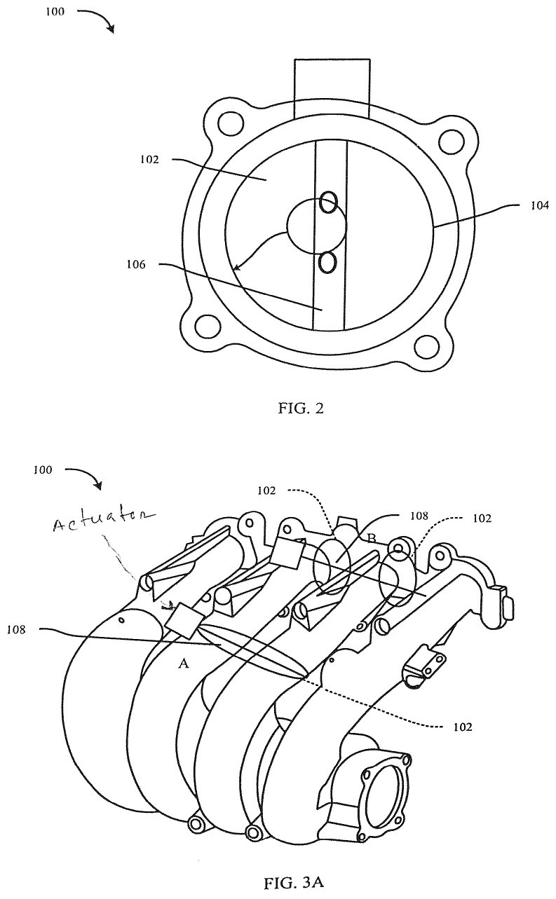

Turning to FIGS. 1 and 2, FIG. 1 illustrates a schematic representation of one or more valves of a pre-defined shape of an assembly to turn off one or more cylinders of an engine, in accordance with an aspect of the present invention. FIG. 2 illustrates a schematic representation of a hole of predefined dimension of the assembly to turn off the one or more cylinders of the engine of FIG. 1, in accordance with an aspect of the present invention.

The assembly 100 to turn off one or more cylinders 102 of an engine to reduce load from a crankshaft includes one or more valves 104 of a pre-defined shape housed inside one or more corresponding intake manifolds of at least one cylinder 102 of the engine. In one embodiment, the one or more valves 104 may correspond to a solenoid valve. In one exemplary embodiment, the pre-defined shape of the one or more valves 104 may correspond to one or more butterfly valves.

In one exemplary embodiment, a single valve may be used to operate multiple cylinders. In another exemplary embodiment, multiple valves 104 may be used to operate the corresponding multiple valves.

In operation, the one or more valves 104 may be configured to operate corresponding one or more lever 108 inside the corresponding one or more cylinders. In such embodiment, operation of the lever 108 may correspond to opening and closing of the lever 108.

Furthermore, each of the one or more valves 104 includes at least one hole 106 of predefined dimension, placed at a pre-defined position in the corresponding at least one valve 104. The at least one hole 106 is configured to reduce effect of negative pressure.

The assembly 100 also includes at least one actuator operatively coupled to the corresponding one or more valves 104. The at least one actuator is configured to operate the corresponding cylinders of the engine.

In one embodiment, the one or more valves 104 may be configured to stop air, compression, fuel, spark, and the like.

In operation, a restriction on the air flow may lead to a negative pressure in the cylinder inside. In order to reduce the negative pressure, the hole 106 in the butterfly valve 104 plate may be fabricated, where always the hole 106 may allow little more than clearance volume air to flow inside cylinders. Size of the hole 106may be proportional to compression ratio. Hence size of the hole 106 may be bigger in petrol engine compared to a same size diesel engine.

In one exemplary embodiment, the assembly 100 may further include a control unit operatively coupled to the corresponding at least one actuator. The control module is configured to transmit a command to at least one of the one or more valves to turn off the corresponding at least one valve in one or more conditions, to reduce negative pressure inside the cylinder of a crankshaft. In one exemplary embodiment, the control unit may correspond to an electronic control module (ECM).

In operation, the assembly 100 is used to switch off completely 50% cylinders of an engine when the engine is in idle condition: due to which a good amount of fuel which will save a significant change in overall engine fuel can be saved.

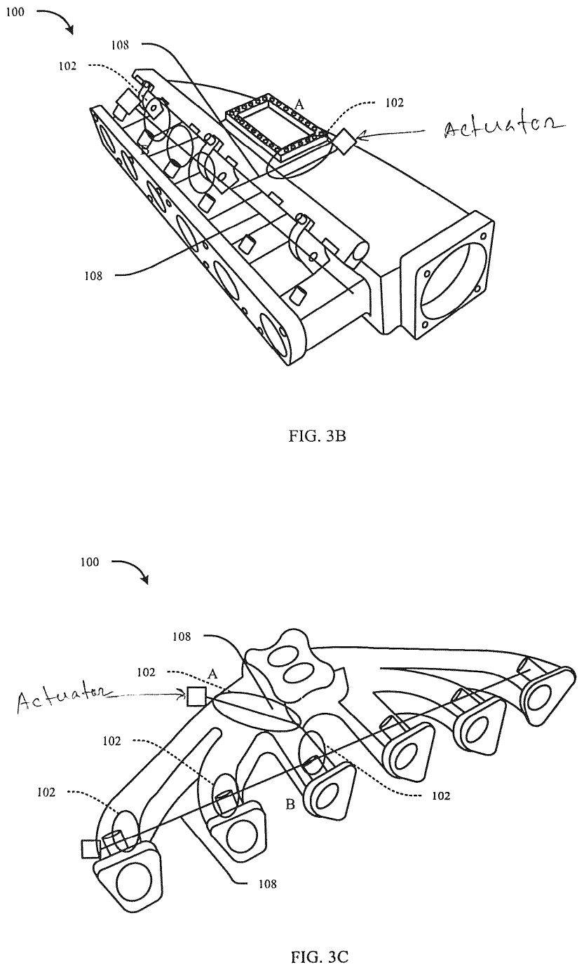

FIG. 3a illustrates a schematic representation of an embodiment representing two types of placement of the valves using the assembly to turn off a four cylinder engine of FIG. 1, in accordance with an aspect of the present invention. The two types of placement of the valves include type A and type B.

In type A, a single valve 104 may be used to operate multiple corresponding one or more lever 108 inside the corresponding one or more cylinders in the engine.

In type B, multiple valve 104 may be used to operate multiple corresponding one or more lever 108 inside the corresponding one or more cylinders in the engine.

In operation, as shown in FIG. 3a, a four-cylinder engine may be used, wherein the

firing order of the engine may be 1-3-4-2.

In operation, adding the butterfly valves in the intake manifold towards the way of cylinder no 2 and 3 and controlling the said cylinders through the control unit and closing the butterfly valves in those cylinders respectively, will stop compression load on crankshaft of two cylinders as there will be no suction then no compression load will be on crankshaft.

Engine will start smoothly with the help of cylinder no 1 and 4 as the compression load will be eliminated from cylinder no 2 and 3. The moment a driver presses clutch for gear shifting, again those butterfly valve will open and allow engine to run with full strength. In the same way fuel can be further saved in different diving like cruise speed condition, deceleration, and idle.

Turning to FIGS. 3b and 3c, FIG. 3b illustrates a schematic representation of another embodiment representing two types of placement of the valves using the assembly to turn off the four cylinders engine of FIG. 1, in accordance with an aspect of the present invention: FIG. 3c illustrates a schematic representation of another embodiment representing two types of placement of the valves using the assembly to turn off the six cylinders engine of FIG. 1, in accordance with an aspect of the present invention.

The two types of placement of the valves include type A and type B.

In type A, a single valve 104 may be used to operate multiple corresponding one or more lever 108 inside the corresponding one or more cylinders in the engine.

In type B, multiple valve 104 may be used to operate multiple corresponding one or more lever 108 inside the corresponding one or more cylinders in the engine.

In operation, as shown in FIGS. 3b and 3c, a six-cylinder engine may be used, wherein the firing order of the engine may be 1-5-3-6-2-4.

The assembly 100 may be implement to start the engine in any multicylinder engine by pulling a lever to stop air flow in all cylinder during cranking only. Once the engine start lever can be release and allow all the cylinders to function normally. The assembly 100 may be implement in existing sold 4 cylinder or above cylinder petrol or diesel engines in car segment, commercial vehicle or industrial engines where ECM controls the engine operation.

In one exemplary embodiment, another set of similar valves with actuator can be implemented for the corresponding cylinders. For example. In a 4 cylinder engine, ECM can be programmed in such a way that the ECM will activate the cylinder deactivation to cylinder number 2 and 3 one time and next time apply the same for cylinder number 1 and 4 to close for no load condition. Then all the cylinders will be used almost uniformly in an engine life cycle.

In another example, for a 6-cylinder engine, ECM can be programmed in such a way that the EMC will activate the cylinder deactivation to cylinder number 4, 5 and 6 one time and next time apply the same for cylinder number 1, 2 ad 3.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### ADVANTAGES OF THE INVENTION

The present invention provides an improved cylinder deactivation system by closing the intake port with a butterfly valve attached with a actuator and operated by ECM.

The present invention also provides a deactivation system which has less production cost and has easy implementation in an existing petrol or diesel engine.

The present invention also provides a deactivation system with an engine to start faster with existing self-stater as the load will be less on crankshaft if close two cylinders and for future engines self-starter and battery cost can be minimized and life can be maximised. For future vehicle production cost can be minimised by putting a comparatively smaller capacity self-starter and battery. The present invention also provides a deactivation system which can replace the multicylinder industrial engines having two self-starters (or higher capacity starter) to start easily using less torque.

The present invention also provides a deactivation system which can reduce the negative pressure inside the cylinder and no effect is produced during compression stroke as the air entered is just the double volume of clearance volume. Hence the deactivation system will be 10% more efficient during cylinder deactivation as compared to the existing systems.

Further, the present invention also provides a means to modify the intake manifold of the existing vehicles to put in place a new wiring to connect with the control unit and software modification in the existing ECM or control unit to activate the butterfly valve to close whenever no load condition is there during engine start and reduce fuel consumption.

1. An assembly to turn off one or more cylinders of an engine to reduce load from a crankshaft, wherein the said assembly comprises:
one or more butterfly valves of a pre-defined shape housed inside one or more corresponding intake manifolds of at least one cylinder of the engine,
wherein each of the one or more butterfly valves comprises at least one hole of a dimension proportional to compression ratio, placed at a pre-defined position in the corresponding at least one butterfly valve, and configured to reduce effect of negative pressure; and
at least one actuator operatively coupled to the corresponding one or more butterfly valves, and configured to operate the corresponding cylinders of the engine.

2. The assembly as claimed in claim 1, wherein the engine comprises one of a petrol engine (spark ignition) or a diesel engine (compressed ignition).

3. The assembly as claimed in claim1, wherein the one or more cylinders comprising the butterfly valve corresponds to one of alternate butterfly valves, butterfly valves in series, or one or more customised butterfly valves.

4. The assembly as claimed in claim 1, wherein the one or more conditions comprises one of a no-load condition, an engine start condition, or a combination thereof.

5. The assembly as claimed in claim 1, comprises a control unit operatively coupled to the corresponding at least one actuator, and configured to transmit a command to at least one of the one or more butterfly valves to turn off the corresponding at least one butterfly valve in one or more conditions, to reduce negative pressure inside the cylinder of a crankshaft.
